(19) United States
(12) Patent Application Publication
(10) Pub. No.: US 2014/0297972 A1
(43) Pub. Date: Oct. 2, 2014

(54) MEMORY CONTROL DEVICE AND MEMORY CONTROL METHOD

(71) Applicant: FUJITSU LIMITED, Kawasaki-shi (JP)

(72) Inventors: Takuya Ikeda, Fukuoka (JP); Hiroaki Kubo, Fukuoka (JP); Nobuyuki Iwasaki, Fukuoka (JP); Yoshinari Sugimoto, Fukuoka (JP); Motoshi Hamasaki, Kawasaki (JP)

(73) Assignee: FUJITSU LIMITED, Kawasaki-shi (JP)

(21) Appl. No.: 14/179,033

(22) Filed: Feb. 12, 2014

(30) Foreign Application Priority Data
Mar. 28, 2013 (JP) 2013-070691

(51) Int. Cl. G06F 12/02

(52) U.S. Cl. CPC G06F 12/023
USPC 711/153

(57) ABSTRACT

A memory control device has a write-request distribution unit and controllers. The write-request distribution unit divides data to be written in a memory and outputs a plurality of divided data blocks obtained by the division while distributing the divided data blocks to a plurality of buses. The controllers write the plurality of divided data blocks output by the write-request distribution unit in the memory through the plurality of buses, with the divided data blocks being in contact with each other in each of the buses.

### CROSS-REFERENCE TO RELATED APPLICATION

This application is based upon and claims the benefit of priority of the prior Japanese Patent Application No. 2013-070691, filed on Mar. 28, 2013, the entire contents of which are incorporated herein by reference.

### FIELD

The present invention relates to a memory control device and a memory control method.

### BACKGROUND

In recent years, in the field of equipment for transmitting packets and the like by using the IP (Internet Protocol), along with the broadening of the bandwidth of the network, the transmission bandwidth which the FPGA (Field Programmable Gate Array) could handle has been broaden. For example, to allow transmission equipment to exhibit high transmission performance of about 80 Gbps on Ethernet™, the memory has to have a wider bus width in accordance with the increase in the transmission bandwidth of the FPGA. However, in the transmission equipment, since the received data are divided based on the bus width of the memory, a large amount of invalid regions are created in the memory along with the increase in bus width due to broadening of the bandwidth. Concretely speaking, in order for the transmission equipment to transmit data of 65 bytes (520 bits), when the bus has a width of 256 bits, only the region of 248 (=256−8) bits is invalid. However, when the bus has a width of 512 bits, the invalid region of as many as 504 (=512−8) bits are created.

The creation of such an invalid region causes decrease in an effective transmission bandwidth of the memory and can be eventually a cause of frame loss because of short of memory capacity. The frame loss can be a big issue for the transmission equipment to perform high speed and high quality transmission. In other words, when the bus width of the memory is increased in the transmission equipment, the maximum transmission performance is improved; however, since the invalid region is likely to increase, it is difficult for the transmission equipment to exhibit high transmission performance with respect to all the data lengths (for example, 64 to 16 Kbytes). In view of the above problems, there is a method in which when the transmission equipment writes data in the memory, a plurality of data are written in the memory without a gap so as not to create the invalid region.
Patent Document 1: Japanese Laid-open Patent Publication No. 2003-288268
Patent Document 2: International Publication Pamphlet No. WO 2009/116115

However, there can be a problem that processes become complex due to the fact that a head position of the data changes by a bit or that a control for preventing other stored data from being erased is performed when writing data. In addition, the data are not always read in the order of being written; therefore, when the transmission equipment reads some data, the transmission equipment sometimes reads other data stored before and after the data; as a result, the transmission bandwidth can decrease at the time of reading. As a measure to improve an effective transmission bandwidth of the memory, other than the above-described measure in which the bus width is broadened, there is a measure in which an operating frequency of the memory itself is increased; however, the FPGA has a limit in frequency which the FPGA handles, and it is difficult for a large improvement in the transmission bandwidth to be expected with this measure.

### SUMMARY

According to an aspect of the embodiments, a memory control device includes a distribution unit and a plurality of controllers. The distribution unit divides data to be written in a memory and outputs a plurality of divided data blocks obtained by the division while distributing the divided data blocks to a plurality of buses. The plurality of controllers write the plurality of divided data blocks output by the distribution unit in the memory through the plurality of buses, the divided data blocks being in contact with each other in each of the buses.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a writing process in a memory control according to the present embodiment;

FIG. 2 is a diagram for describing a reading process in the memory control according to the present embodiment;

FIG. 3 is a diagram illustrating a configuration of a memory control device;

FIG. 4A is a diagram for describing a writing process of the related art;

FIG. 4B is a diagram for describing the writing process of the present embodiment;

FIG. 5A is a diagram illustrating how divided data blocks D11 to D16 of data D1 are distributed to divided blocks B1 to B4;

FIG. 5B is a diagram illustrating how divided data blocks D21 to D237 of data D2 are distributed to the divided blocks B1 to B4;

FIG. 5C is a diagram illustrating how divided data blocks D31 to D34 of data D3 are distributed to divided blocks B1 to B4;

FIG. 6A is a diagram illustrating an example of conditions for describing how to calculate read addresses;

FIG. 6B is a diagram illustrating an example of a read request for describing how to calculate the read addresses;

FIG. 7 is a diagram illustrating an example of the read addresses calculated by a read-request distribution unit for each of the divided blocks;

FIG. 8 is a diagram illustrating how the read addresses are stored in a read request buffer;

FIG. 9 is a diagram illustrating an example of the read request for describing how to rearrange read data;

FIG. 10 is a diagram for describing a process in which a read-data distribution unit takes the read data from the read data buffer into a rearrangement buffer;

FIG. 11 is a diagram for describing a rearrangement process to be performed by the read-data distribution unit;

FIG. 12 is a flowchart for describing the writing process to be performed by the memory control device;

FIG. 13A is a diagram illustrating how the divided data blocks of the data are written in the memory;

FIG. 13B is a diagram illustrating how data IDs, data lengths, and head block IDs are stored in a data management unit;

FIG. 14 is a flowchart for describing the reading process to be performed by the memory control device;

FIG. 15 is a diagram illustrating how the divided data blocks of the data are read from the memory;

FIG. 16 is a diagram illustrating how the read data are distributed from the read data buffer to the rearrangement buffer;

FIG. 17 is a diagram illustrating how the divided data blocks are rearranged by a selector when the data are output;

FIG. 18 is a diagram for describing an effect of the memory control according to the present embodiment in contradistinction to the related art; and

FIG. 19 is a diagram for describing a process for resolving conflict between read and write according to Modified Example 1.

### DESCRIPTION OF EMBODIMENTS

Preferred embodiments will be explained with reference to accompanying drawings. Note that the memory control device or the memory control method disclosed in the present application is not limited by the following embodiment.

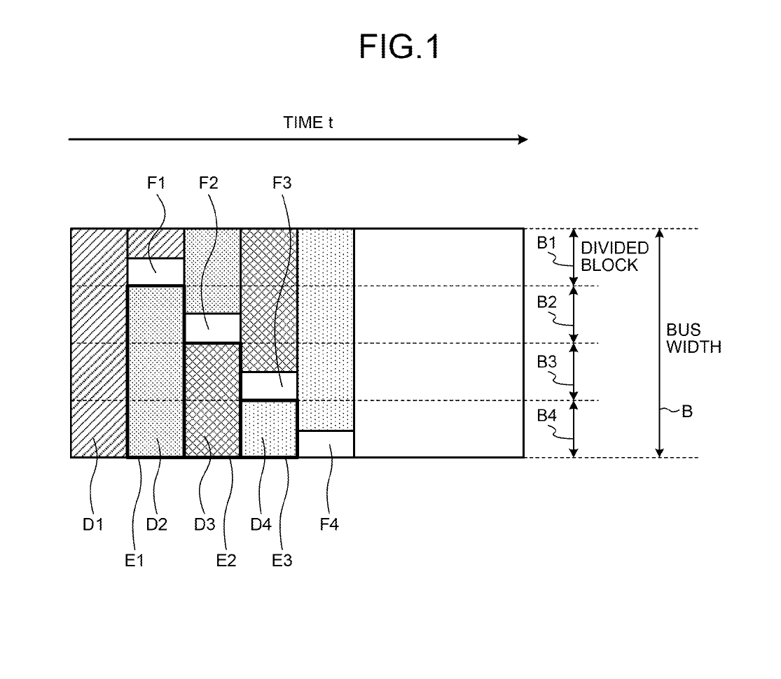

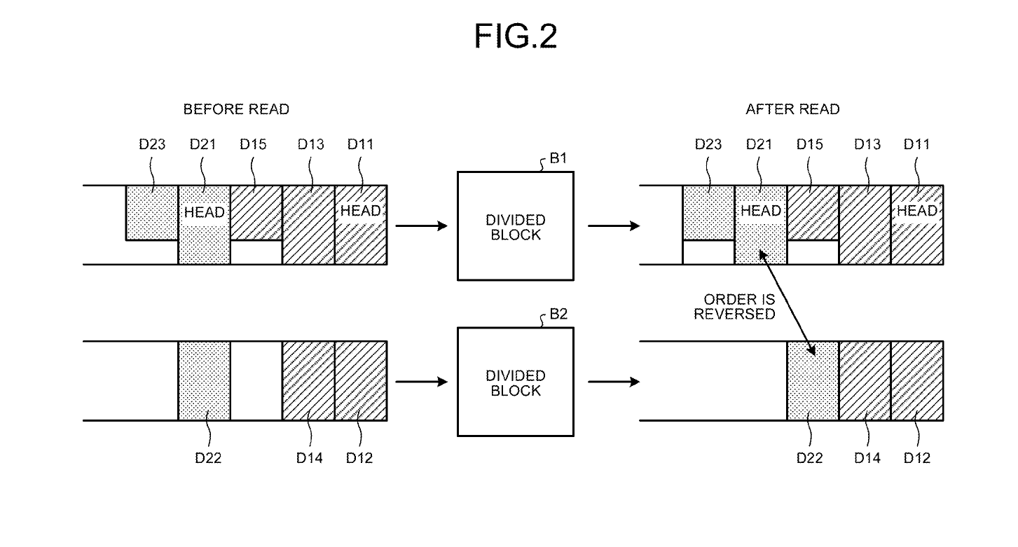

First, with reference to FIG. 1 and FIG. 2, a memory control according to the present embodiment will be schematically described. FIG. 1 is a diagram for describing a writing process in a memory control according to the present embodiment. As illustrated in FIG. 1, the bus width B is divided into four divided blocks B1 to B4, and each of the divided blocks B1 to B4 is individually controlled by each of four controllers to be described later. In the writing process, data D1 to D4 to be written are divided into quarters in a bus direction (the vertical direction in FIG. 1), and then evenly distributed to the divided blocks B1 to B4. For example, to blocks (for example, residual blocks E1) remaining after the data D1 were distributed, the data D2, which are the next write data, are distributed. Further, to blocks (for example, residual blocks E2) remaining after the data D2 were distributed, the data D3, which are the next write data, are distributed. Further, to a block (for example, a residual block E3) remaining after the data D3 were distributed, the data D3, which are the next write data, are distributed. The residual regions F1 to F4 each created in the divided blocks B1 to B4 are invalid regions. As described above, in the memory control according to the present embodiment, the memory control device performs the writing process of the different data D1 to D4 by the units of the divided blocks B1 to B4, with no space the size of the divided block left therebetween, thereby enabling effective use of the limited bus width; as a result, the loss of transmission bandwidth can be reduced.

As described above, the memory control device divides each data D1 to D4 and then distributes the divided data blocks to the divided blocks B1 to B4 to write; thus, by performing the reading process on the same block to which the data were distributed at the time of writing, the data can be read even in the case that the data are stuffed. In addition, the memory control device performs a read control individually on each of the divided blocks B1 to B4; thus, even when different data (for example, the data D1 and the data D2) are stored in each of the divided blocks B1 to B4, a concurrent-like reading process can be performed. As a result, the invalid region is decreased.

The detail will be described later, but in the present embodiment, each written data D1 to D4 are managed with information (a write pointer) indicating a data ID, the storage location of the data, a data length, a block ID as a head of the data, and a data part (type) indicated by the write pointer. In the writing process, the memory control device stores the above pieces of information in a memory different from a memory 20, which is an object to be controlled; and in the reading process, the memory control device obtains the above pieces of information corresponding to the data to be read, and thereby calculating an address to be used for the reading process.

The above pieces of information will be described in detail. The data ID is information (for example, a number) for identifying the data. The write pointer indicates a pointer in which the data were written. The pointer is a memory space having a predetermined capacity (for example, 512 bytes) different from the bus width (64 bytes). The memory control device controls the data by the unit of the pointer, and one pointer corresponds to a plurality of memory addresses. The memory control device may assign a requested number to other pointers when the data more than the capacity (for example, 512 bytes) of one pointer are written in the memory.

The data length is the number of bits of the data (write data) to be written. A number of times of read by the controllers is calculated by dividing the data length by 128 bits (16 bytes), which is the width of the divided bus. The ID of the block corresponding to the head of the data (hereinafter, written as “head block ID”) indicates which block of the four divided blocks B1 to B4 the head part of the data is located in. The memory control device identifies the locations of the read data, considering the block indicated by the head block ID as the head (starting position of the data). The type is the information for indicating which position the data part indicated by the corresponding write pointer corresponds to, the head, the middle, or the tail in the whole data. The value of the type is used for an internal process including calculation of the read address and restoration of the data.

In the following description, in order to clearly distinguish the data to be divided from the data having obtained by dividing, the data to be divided are simply written as “the data”, and the data having been divided are written as “the divided data blocks.” For example, the data D1 to be divided are divided into four divided data blocks D11, D12, D13, and D14 prior to the writing process, and then the divided data blocks are combined again in the reading process, whereby the data D1 are eventually restored.

Next, since the reading process is performed on the divided blocks B1 to B4 in the order of becoming readable, the data D1 to D4 are not necessarily read out in order from the head part. In other words, the order of read-out may be reversed between the divided blocks B1 to B4. FIG. 2 is a diagram for describing the reading process in the memory control according to the present embodiment. Here, in FIG. 2, for the sake of convenience of description, it is assumed that the number of the divided blocks is two, and the data D1 and D2 to be read are configure with the divided data blocks D11 to D15 and D21 to D23, respectively. As illustrated in FIG. 2, it is assumed that when the data D1 are read out, the reading process has to be performed three times on the divided block B1 and twice on the divided block B2, and that when the data D2 are read out, the reading process has to be performed twice on the divided block B1 and once on the divided block B2. In this case, at the third read access to the divided blocks B1 and B2, the divided data block D22, which are a part of the data D2, is read out from the divided block B2. On the other hand, since the divided data block D21 is read out at the fourth read access to the divided blocks B1 and B2, the order of read is reversed in the data D2. To address this issue, the memory control device calculates the positions of the divided data blocks D21 to D23, which constitute the data D2, based on the above pieces of information, and performs a process (a rearrangement process) for rearranging the divided data blocks D21 to D23 at the right positions.

In the present embodiment, it is assumed that a memory control device 10 is applied to an IP transmission device which has QoS (Quality of Service) functions for 80 Gbps Ethernet, but the application is not limited thereto and can be other devices. The memory control device 10 performs, in data processing between a queue management unit and an output interface in the IP transmission device, read/write control individually on each of the memory buses divided into four parts.

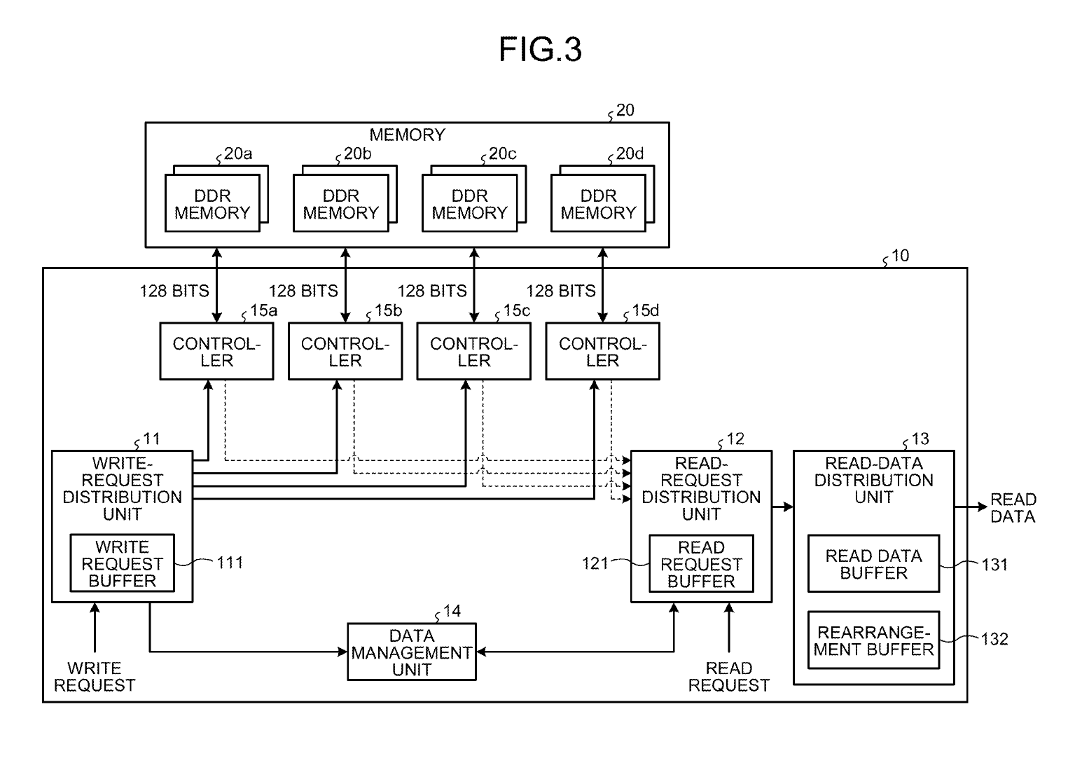

A configuration of the memory control device 10 according to the embodiment disclosed in the present application will be described. FIG. 3 is a diagram illustrating the configuration of the memory control device 10. As illustrated in FIG. 3, the memory control device 10 has a write-request distribution unit 11, a read-request distribution unit 12, a read-data distribution unit 13, a data management unit 14, and controllers 15a to 15d. These components are connected so that the components can be input and output signals and data unidirectionally or bi-directionally.

Upon the input of the write request, the write-request distribution unit 11 divides the write data and distributes the divided data blocks to the controllers 15a to 15d. The write-request distribution unit 11 has a write request buffer 111, and the write request buffer 111 stores therein the write data and the requested write pointers (a plurality of memory address). For example, the write pointer #10 corresponds to memory addresses #100, #101, #102, . . . .

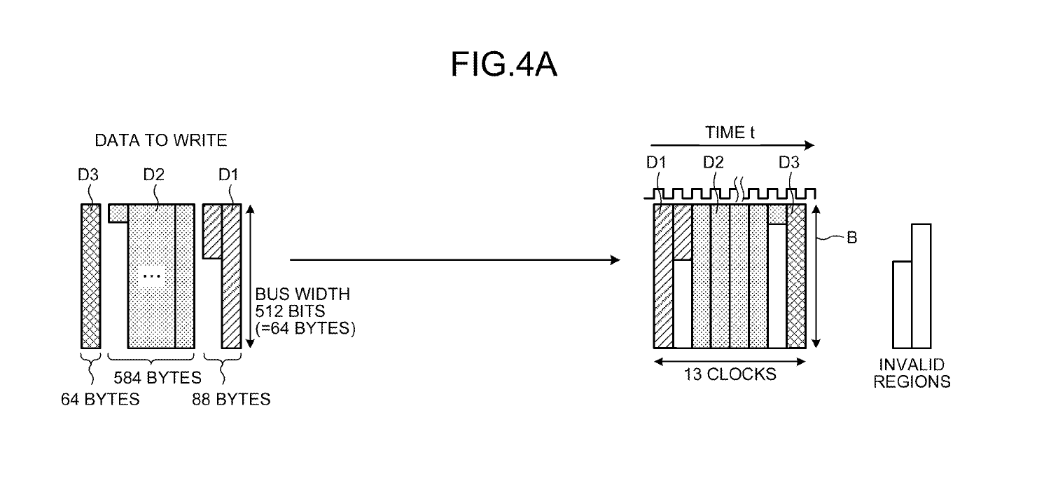

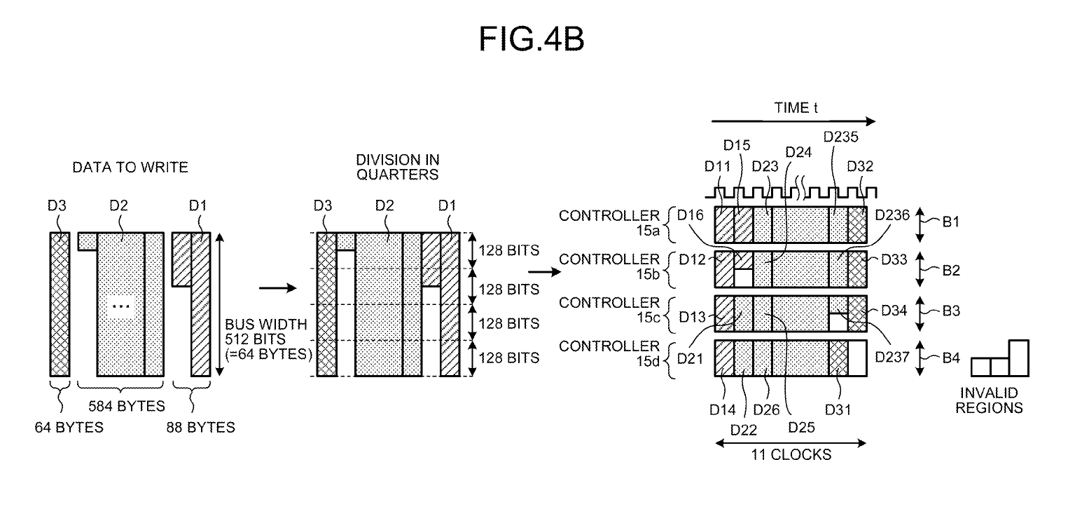

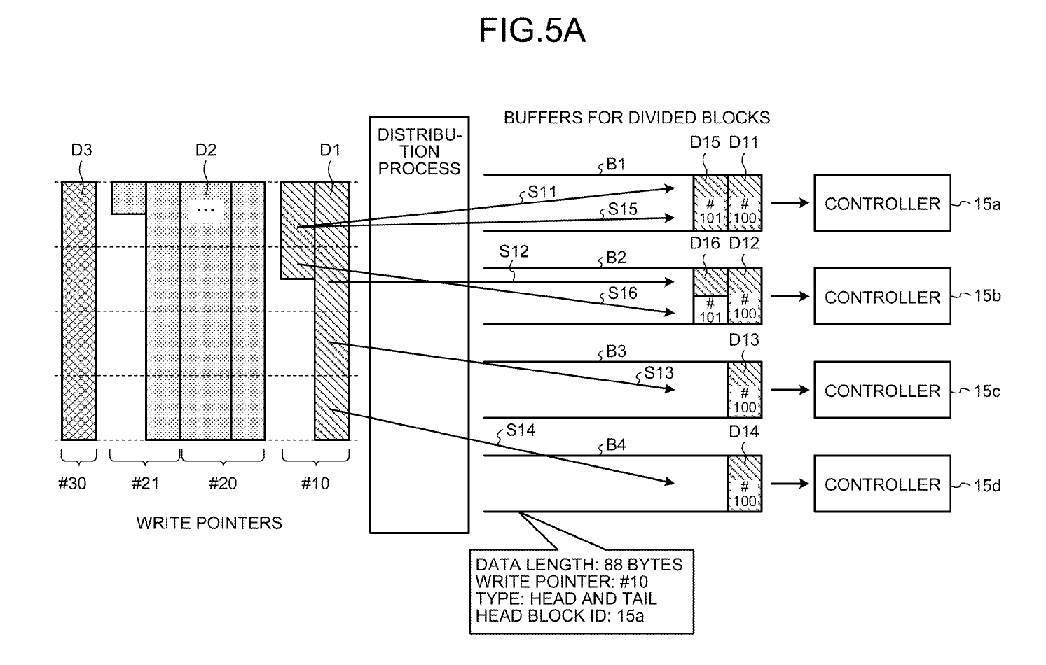

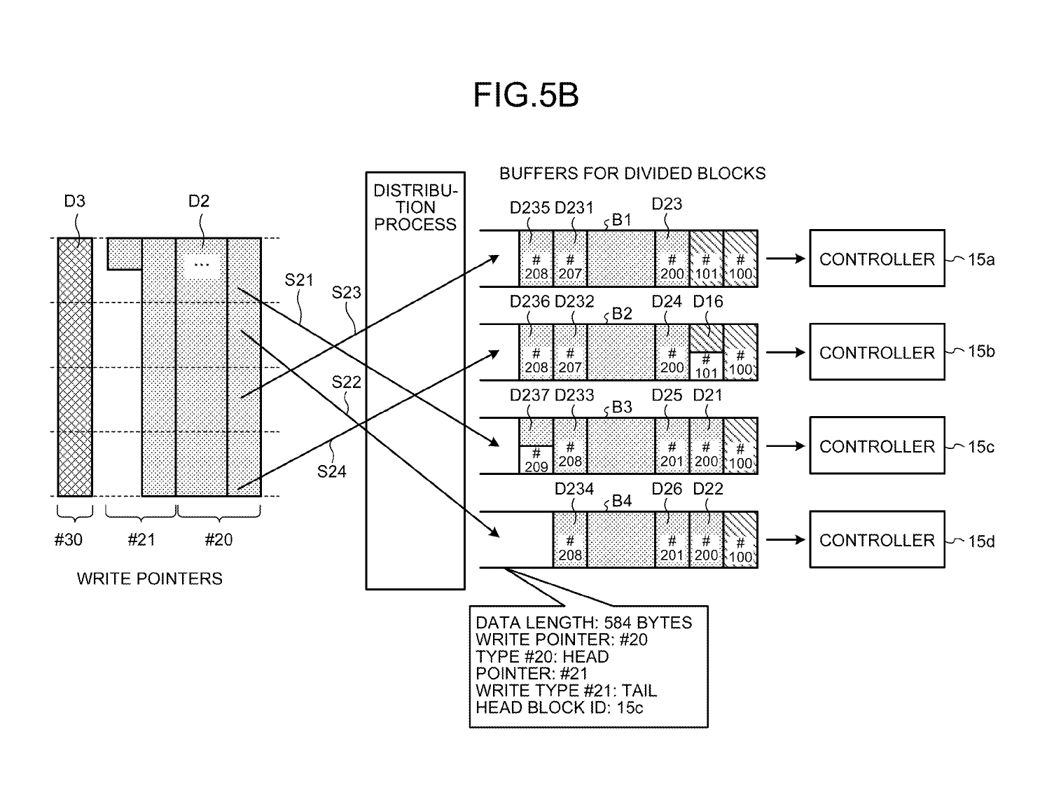

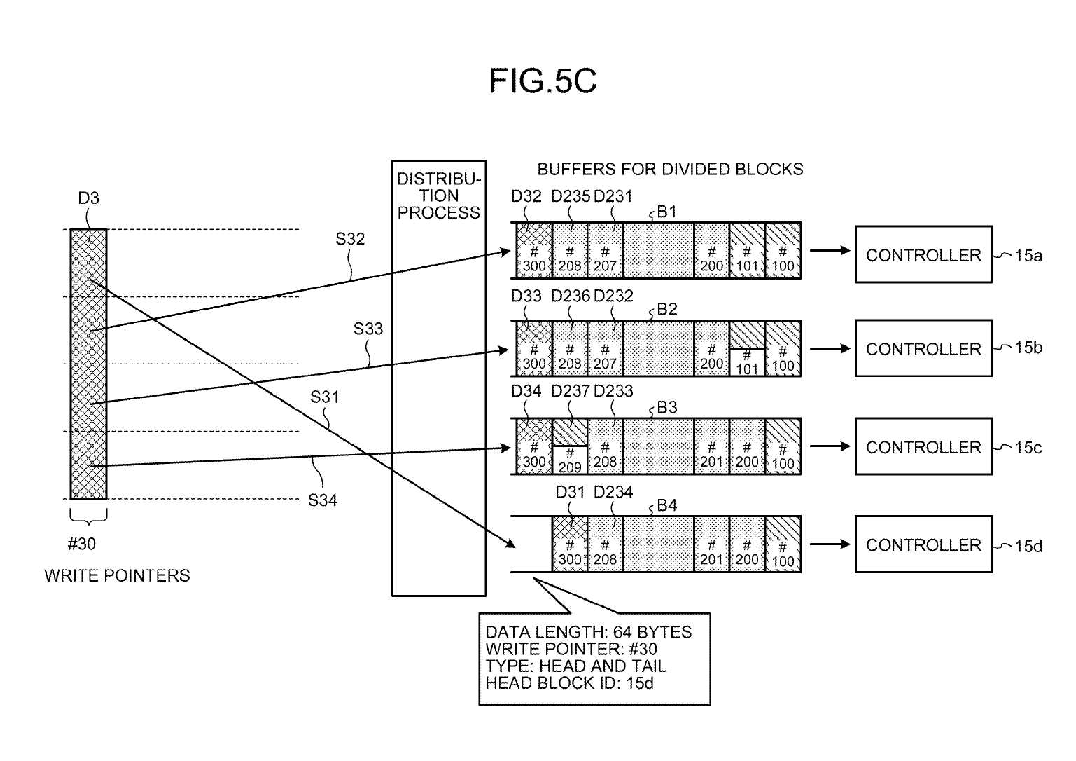

Then, with reference to FIG. 4A to FIG. 5C, the process of the write-request distribution unit 11 will be described in more detail. FIG. 4A is a diagram for describing the writing process of the related art. As illustrated in FIG. 4A, in the case that there are three blocks of data to be written and the data lengths of the data D1 to D3 are each 88 bytes, 584 bytes, and 64 bytes, respectively, the data are not divided and written in the memory as they are in the related art. Therefore, when the bus width B is 64 bytes, it takes time equivalent to 13 clocks for the writing process to be finished, and at least 80 bytes (32 bytes for the data D1 plus 48 bytes for the data D2) of invalid regions are created.

FIG. 4B is a diagram for describing the writing process of the present embodiment. In the present embodiment, being different from the above related art, the bus width B and each of the data D1 to D3 are divided into quarters as illustrated in FIG. 4B. Further, the divided data blocks D11 to D16, D21 to D237, and D31 to D34 are sequentially stored in the divided blocks B1 to B4 in the direction of the bus width B along with the time t, with the divided data blocks being in contact with each other. Thus, when the bus width B is 64 bytes, it only takes time equivalent to 11 clocks for the writing process to be finished, and the invalid regions are 48 bytes or less. Consequently, the memory control device 10 according to the present embodiment realizes reduction in the time requested for the writing process and reduction in the invalid regions.

FIG. 5A is a diagram illustrating how the divided data blocks D11 to D16 of the data D1 are distributed to the divided blocks B1 to B4. As illustrated in FIG. 5A, after the data D1 are divided in the direction of the bus width B and become the divided blocks B1 to B4, the divided blocks B1 to B4 are cyclically distributed to all the divided blocks B1 to B4, in order from the divided block B1, which has the shortest waiting time (S11 to S16). The write addresses #100, #101, . . . , which are the storage locations for the divided data blocks D11 to D16, are determined by repeatedly incrementing by one a head address #100 calculated based on the write pointer #10. Consequently, the data D11 and D15 are stored in the divided block B1 connected to the controller 15a, and the data D12 and D16 are stored in the divided block B2 connected to the controller 15b. Further, the data D13 are stored in the divided block B3 connected to the controller 15c, and the data D14 are stored in the divided block B4 connected to the controller 15d. In the example illustrated in FIG. 5A, the data identified by the write pointer #10 are the whole of the data D1, and thus include the head divided data block D11 and the tail divided data block D16. Thus, “head” and “tail” are set as the type of the written data D1.

FIG. 5B is a diagram illustrating how the divided data blocks D21 to D237 of the data D2 are distributed to the divided blocks B1 to B4. In the case that the data D1 and D2, which are requested to be written, are consecutive as described in the present embodiment, the divided block (divided block B3) which follows the divided block B2, in which the tail divided data block D16 of the data D1 just before the following data D2 are written, has the shortest waiting time. Thus, as illustrated in FIG. 5B, the divided data blocks D21 to D237 of the data D2 are cyclically distributed to all the divided blocks B1 to B4, in order from the divided block B3 (S21 to S24). The write addresses #200, #201, . . . , which are the storage locations for the divided data blocks D21 to D237, are determined by repeatedly incrementing by one a head address #200 calculated based on the write pointer #20. Consequently, the divided data blocks D21, D25, . . . , D233, and D237 are stored in the divided block B3 connected to the controller 15c, and the data D22, D26, . . . , D234 are stored in the divided block B4 connected to the controller 15d. Further, the data D23, . . . , D231, and D235 are stored in the divided block B1 connected to the controller 15a, and the data D24, . . . , D232, and D236 are stored in the divided block B2 connected to the controller 15b.

In the example illustrated in FIG. 5B, the data identified by the write pointer #20 are the front half part of the data D2, and thus include the head divided data block D21 but do not include the tail divided data block D237. Thus, “head” is set as the type (#20) of the written data D2. On the other hand, the data identified by the write pointer #21 are the rear half part of the data D2, and thus do not include the head divided data block D21, but include the tail divided data block D237. Thus, “tail” is set as the type (#21) of the written data D2.

FIG. 5C is a diagram illustrating how the divided data blocks D31 to D34 of the data D3 are distributed to the divided blocks B1 to B4. In the case that the data D2 and D3, which are requested to be written, are consecutive as described in the present embodiment, the divided block (divided block B4) which follows the divided block B3, in which the tail divided data blocks D237 of the data D2 just before the following data D3 are written, has the shortest waiting time. Thus, as illustrated in FIG. 5C, the divided data blocks D31 to D34 of the data D3 are cyclically distributed to all the divided blocks B1 to B4, in order from the divided block B4 (S31 to S34). The write addresses #300, #301, . . . , which are the storage locations for the divided data blocks D31 to D34 are determined by repeatedly incrementing by one the head address #300 calculated based on the write pointer #30. Thus, the divided data block D31 is stored in the divided block B4 connected to the controller 15d, and the data D32 are stored in the divided block B1 connected to the controller 15a. Further, the data D33 are stored in the divided block B2 connected to the controller 15b, and the data D34 are stored in the divided block B3 connected to the controller 15c. In the example illustrated in FIG. 5C, in the same manner as FIG. 5A, the data identified by the write pointer #30 are whole of the data D3, and thus include the head divided data block D31 and the tail divided data block D34. Thus, “head” and “tail” are set as the type of the written data D3.

As described above, since the write-request distribution unit 11 writes the write data having been divided in the different regions (divided blocks B1 to B4), the write data which were conventionally processed at different timings can be parallelly processed at the same timing. In addition, regarding the memory control device 10, the maximum invalid region in each block is reduced by dividing the bus width B, whereby the parallel loss can be reduced. Further, by preventing creation of the divided block in which noting is written, the memory control device 10 can minimize the gap between the writing processes when the writing processes successively occurs. Thus, the percentage of the invalid regions in the signal being actually read is reduced.

As a result, reduction in the transmission bandwidth is avoided.

Upon input of the read request, the read-request distribution unit 12 reads out the data D1 to D3 from each of the divided blocks B1 to B4. In particular, the read-request distribution unit 12 identifies the data to be read by referring to the above pieces of information (the data ID, the write pointer, the data length, the head block ID, and the type) based on the pointer having been requested to be read. For example, the read-request distribution unit 12 calculates the head address of the read data from the pointer having been requested to be read, and then calculates the address to which the reading process is to be performed, from the head block ID and the data length. These calculation processes are performed individually for each of the divided blocks B1 to B4. Thus, the head and the tail of the divided data blocks to be read, of the divided data blocks D11 to D34, are identified in the unit of the divided block.

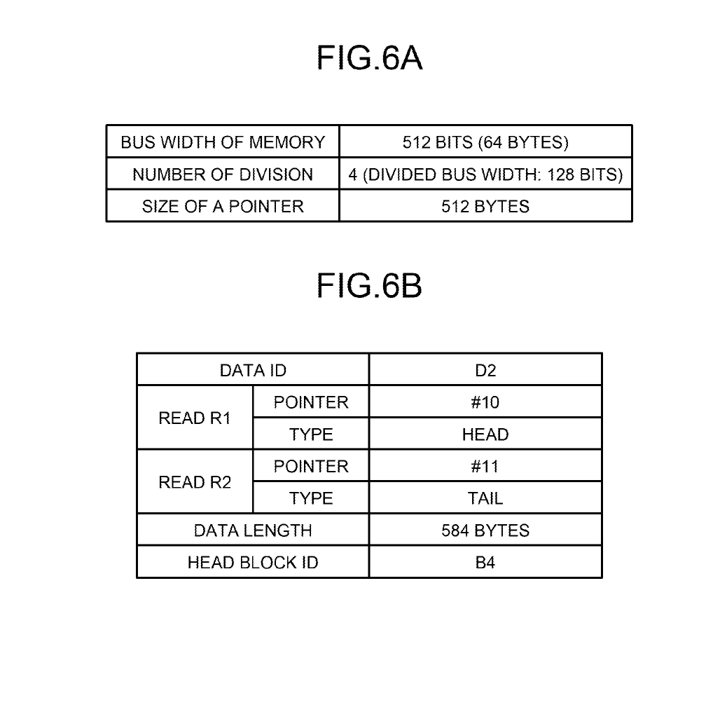

Next, with reference to FIG. 6A to FIG. 8, the process of the read-request distribution unit 12 will be described in detail. FIG. 6A is a diagram illustrating an example of conditions for describing how to calculate the read addresses. As preconditions for the description, for example, the conditions of FIG. 6A are set. That is, in the following description, it is assumed that the bus width B of the memory 20 is 512 bits (64 bytes), the number of division of the bus is four, and the size (capacity) of one pointer is 512 bytes.

FIG. 6B is a diagram illustrating an example of the read request for describing how to calculate the read addresses. In the present embodiment, it is assumed that, under the conditions illustrated in FIG. 6A, the read request illustrated in FIG. 6B is input into the read-request distribution unit 12. As illustrated in FIG. 6B, the read request is a request for the data having the data ID “D2”, and the data are identified by the two different pointers #10 and #11. In addition, the data to be read have the data length “584 bytes” and the head block ID “B4”.

When the above-mentioned read request is input into the read-request distribution unit 12 under the above conditions, the size of one pointer is 512 bytes and the bus width B of the memory is 64 bytes, whereby the number of memory address for one pointer is 8 (=512÷64). This value is unique to the circuit of the memory 20.

First, as for the pointer #10, since the head address is calculated by the formula: pointer×(the number of memory addresses for one pointer), the head address is calculated to be 80 by the formula 10×8. Further, since the type of the pointer #10 of a read R1 does not contain “tail” (see FIG. 6B), the pointer #10 are read with respect to all the addresses (eight addresses). As a result, the number of read of the pointer #10 is calculated to be 8. Further, since the head block ID is “B4” (see FIG. 6B), the read-request distribution unit 12 only has to make read accesses, with respect to the pointer #10, in order from the divided block B4, to each of the divided blocks B1 to B4 equally eight times.

Similarly, as for the pointer #11, since the head address is calculated by the formula: pointer×(the number of memory addresses for one pointer), the head address is calculated to be 88 by the formula 11×8. Further, since the type of the pointer #11 of a read R2 includes “tail” (see FIG. 6B), the number of read of each of the divided blocks B1 to B4 is calculated, with respect to the pointer #11, in a different manner from the case of the pointer #10. The calculation method will be described below.

First, the length of the data (the length of the remaining data of the data D2) indicated by the pointer #11 is calculated by the formula: (the total data length) mod (the size of one pointer). In the present embodiment, since it is assumed that the data length is 584 bytes (see FIG. 6B) and the size of one pointer is 512 bytes (see FIG. 6A), the length of the remaining data is calculated to be 72 bytes by the remainder of 584÷512. Since the number of read of the pointer #11 is calculated by the formula: (the length of the remaining data)÷(the width of the divided bus), the number of read of the pointer #11 is calculated to be 5 by the equation: 72÷16=4.5. Further, since the head block ID is “B4” (see FIG. 6B) and the number of division of the bus width B is four (see FIG. 6A), the number of read of each of the divided blocks B1 to B4 is 1, 1, 1, and 2, respectively. Thus, with respect to the pointer #11, the read-request distribution unit 12 only has to make equally one read access to the divided blocks B1 to B4 in order from the divided block B4 and then make one read access only to the divided block B4.

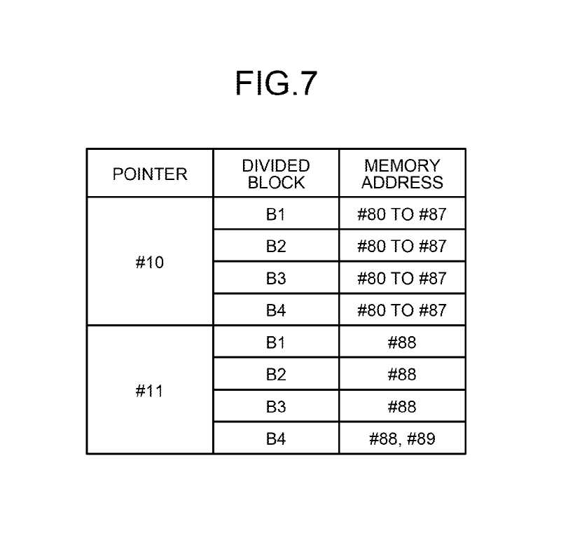

Based on the number of read, the read addresses of each of the divided blocks B1 to B4 are obtained. FIG. 7 is a diagram illustrating an example of the read addresses calculated by the read-request distribution unit 12 for each of the divided blocks B1 to B4. As illustrated in FIG. 7, with respect to pointer #10, eight memory addresses #80 to #87 are evenly calculated for each of the divided blocks B1 to B4. Further, with respect to pointer #11, one memory address #88 is calculated for each of the divided blocks B1 to B3, and two memory addresses #88 and #89 are calculated for the divided block B4.

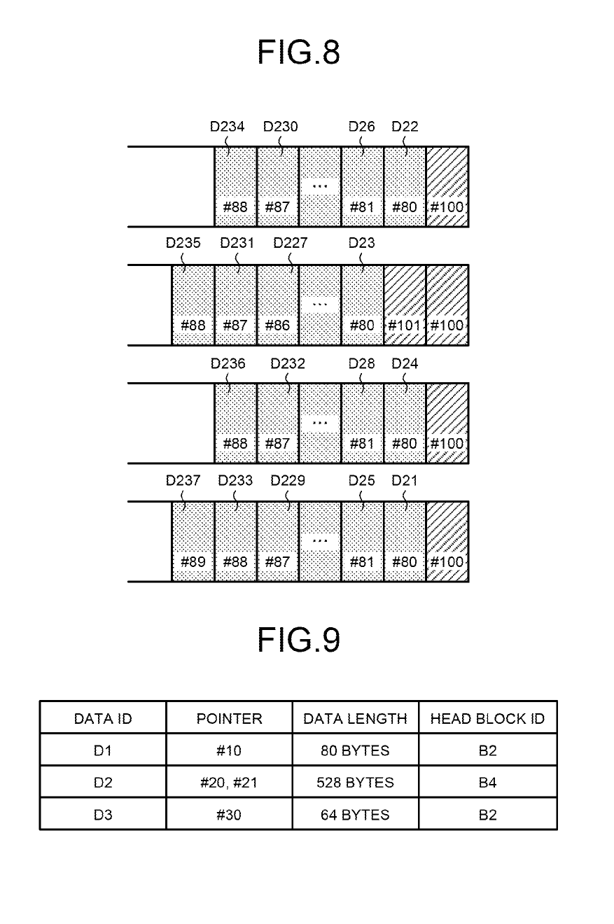

Based on the above calculation results, the read-request distribution unit 12 stores the calculated read addresses #80 to #89 in the regions, in a read request buffer 121, corresponding to the divided blocks B1 to B4. FIG. 8 is a diagram illustrating how the read addresses are stored in the read request buffer 121. As illustrated in FIG. 8, the read addresses are stored in the read request buffer 121, with no space left between the read addresses in each of the divided blocks B1 to B4. Thus, similarly to the case of the writing process, the percentage of the invalid region in the actually read signal is reduced. As a result, the reduction in the transmission bandwidth is prevented before it happens.

The read-data distribution unit 13 rearranges the read data being input from the read-request distribution unit 12. In particular, the writing process starts with the head divided data blocks of each of the data D1 to D3, but in the reading process, the divided data block which first becomes readable is not always the head divided data blocks of each of the data D1 to D3 but depends on the immediately preceding reading process. In the present embodiment, in order to reduce the waiting time, the read-request distribution unit 12 immediately starts the reading process on the divided block even if the divided block does not store the head divided data block therein. Thus, if needed, the read-data distribution unit 13 rearranges the divided data blocks in order to correctly restore the divided data blocks having been read in the original normal state prior to division.

With reference to FIG. 9 to FIG. 11, the process of the read-data distribution unit 13 is described in more detail. FIG. 9 is a diagram illustrating an example of the read request for describing how to rearrange the read data (divided data blocks). In the present embodiment, it is assumed that the read request illustrated in FIG. 9 is input into the read-request distribution unit 12 under the conditions illustrated in FIG. 6A. As illustrated in FIG. 9, the read request requests the three blocks of data D1, D2, and D3, which are identified by the data ID “D1”, “D2”, and “D3”. The data D1, D2, and D3 are identified by the pointer #10, #20 & #21, and #30, respectively. The data D1 are the read data which have the head block ID “B2” and the data length of 80 bytes. The data D2 are the read data which have the head block ID “B4” and the data length of 528 bytes. The data D3 are the read data which have the head block ID “B2” and the data length of 64 bytes.

The read-data distribution unit 13 reads out, when distributing the read request, the divided data blocks from the read request buffer 121 into a read data buffer 131 in order from the head divided data blocks by using the above pieces of information (the data ID, the write pointer, the data length, the head block ID, and the type) stored in the data management unit 14. Thus, the read data (divided data blocks) are accumulated in the read data buffer 131 for each of the divided blocks B1 to B4. The read-data distribution unit 13 rearranges the accumulated read data in order from the head of a FIFO (First In First Out).

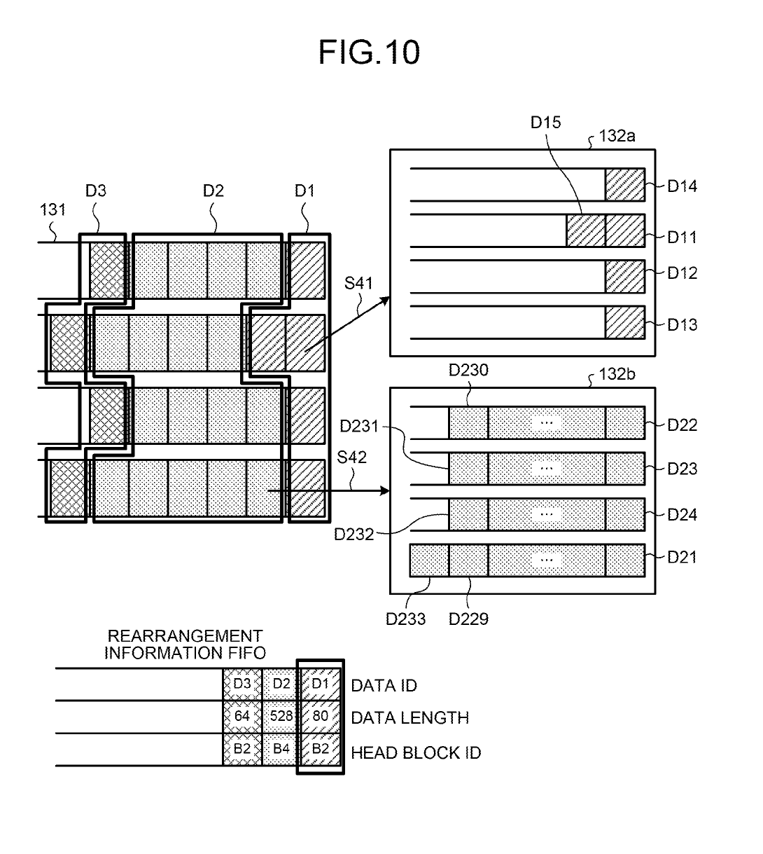

The rearrangement process of the read data (divided data blocks) will be described in more detail below. FIG. 10 is a diagram for describing the process in which the read-data distribution unit 13 takes the read data D1 and D2 from the read data buffer 131 into rearrangement buffers 132a and 132b. First, the read-data distribution unit 13 calculates, from the data length of the read data, how many divided blocks the reading process needs to be performed on. For example, in the case that the read data is the data D1, since the data length is 80 bytes (see FIG. 9), the read-data distribution unit 13 calculates the number of the divided blocks to be 5 by dividing 80 bytes by 16 bytes, which is the width of the divided bus. Next, the read-data distribution unit 13 performs the reading process five times, which is the number of the above divided block, in order from the head block ID “B2” (see FIG. 9), and stores the data D1 having been divided in the rearrangement buffer 132a.

Similar processes are performed on the data D2 and D3. In particular, when having finished reading from the all divided blocks B1 to B4 in which the data D1 are stored, the read-data distribution unit 13 starts to read out the following next data D2, and at the same time switches a rearrangement buffer 132 from the rearrangement buffer 132a to the rearrangement buffer 132b. With this arrangement, the different buffers are used for each of the data D1, D2, and D3 in the rearrangement process. Thus, the read-data distribution unit 13 can easily take out the same data (for example, the data D2) from the data D1, D2, and D3 stored in the read data buffer 131 in an intricate way as illustrated in FIG. 10.

As described above, the read-data distribution unit 13 transfers the data D1, D2, and D3 from the read data buffer 131 to the rearrangement buffer 132 in order of the ID. If the read data buffer 131 is empty when transferring, the read-data distribution unit 13 waits until new data are stored in the read data buffer 131; and when new data are stored, the read-data distribution unit 13 starts to transfer the data.

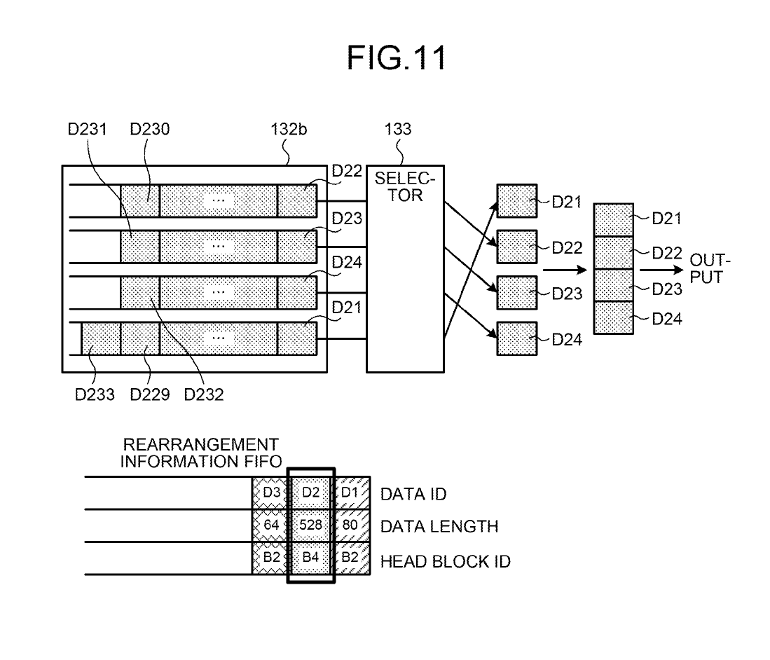

Next, taking the data D2 as an example, the rearrangement process will be described. FIG. 11 is a diagram for describing the rearrangement process to be performed by the read-data distribution unit 13. As illustrated in FIG. 11, when all the data D2 have been stored in the rearrangement buffer 132b, the read-data distribution unit 13 starts to read out the divided data blocks D21 to D233. In this process, the read-data distribution unit 13 rearranges the divided data blocks D21 to D233 by using a selector 133 so that the divided data block D21 stored in the divided block B4, which is the head block ID, is located at the head of the data D2, and then outputs the data D2 to outside of the device. With this arrangement, the normal data which is identical to the data D2 prior to division can be output.

The data management unit 14 stores, when performing the writing process, the above pieces of information so that the divided data blocks D11 to D34 distributed by the write-request distribution unit 11 can be correctly read by the memory control device 10. The above pieces of information are, for example, the data IDs, the write pointers, the data lengths, the head block IDs, and the types of the data D1 to D3. These pieces of information are obtained from the data management unit 14 when performing the reading process, and used, for example, to identify memory addresses to be read or to identify the divided blocks to which the memory addresses are assigned.

The controllers 15a to 15d are memory interfaces for controlling the memory 20. The controllers 15a to 15d are each connected to each of four pairs of DDR (Double Data Rate) memories 20a to 20d constituting the memory 20, through four buses B11 to B14. In the present embodiment, the bus width is assumed to be 512 bits in total; thus, each of the controllers 15a to 15d individually controls each of the corresponding DDR memories 20a to 20d through the four 128-bit buses B11 to B14.

Next, with respect to the operation of the memory control device 10, the writing process and the reading process will be separately described. In the description of the operation, similarly to the above description of the configuration, a case is exemplified in which the bus width B of 64 bytes is divided into quarters; however, the number of division is not limited to four.

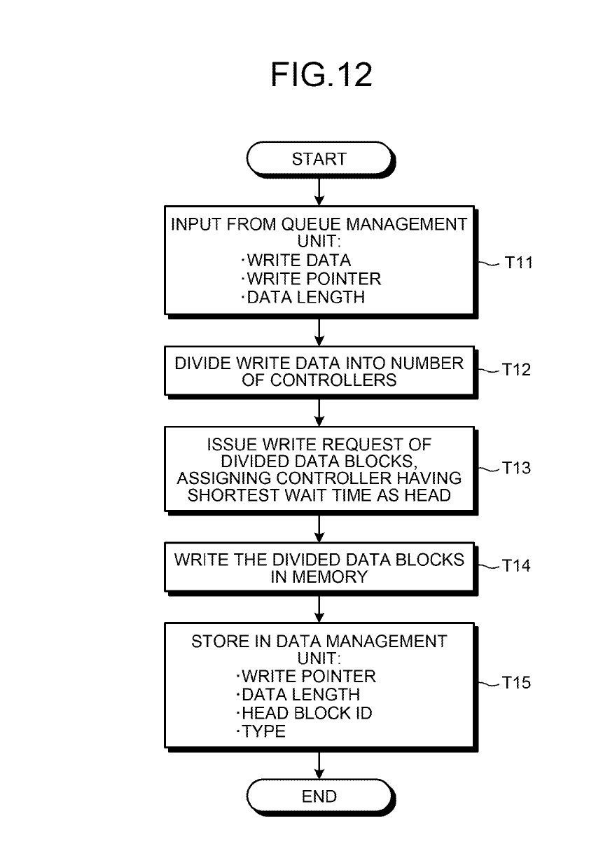

First, the writing process will be described. FIG. 12 is a flowchart for describing the writing process to be performed by the memory control device 10.

At T11 of FIG. 12, the write-request distribution unit 11 inputs the write data and the above pieces of information (for example, the write pointers and the data lengths) from the queue management unit of the IP transmission device having the memory control device 10. At T12, the write-request distribution unit 11 divides the write data input at T11 into the same number of parts as the controllers 15a to 15d. Thus, the write data are divided into the divided data blocks of 16 bytes, which is the width of the divided blocks B1 to B4.

At T13, the write-request distribution unit 11 transfers the write request input to the controllers 15a to 15d, considering as the head the divided block, of the empty divided blocks, having the shortest waiting time in the controllers 15a to 15d. In this process, the write-request distribution unit 11 transfers the write requests of the divided data blocks to the controller, in order from the controller having the divided block having the shortest waiting time in the controllers 15a to 15d. At T14, the controllers 15a to 15d writes the divided data blocks in the corresponding DDR memories 20a to 20d in the memory 20, according to the write request from the write-request distribution unit 11.

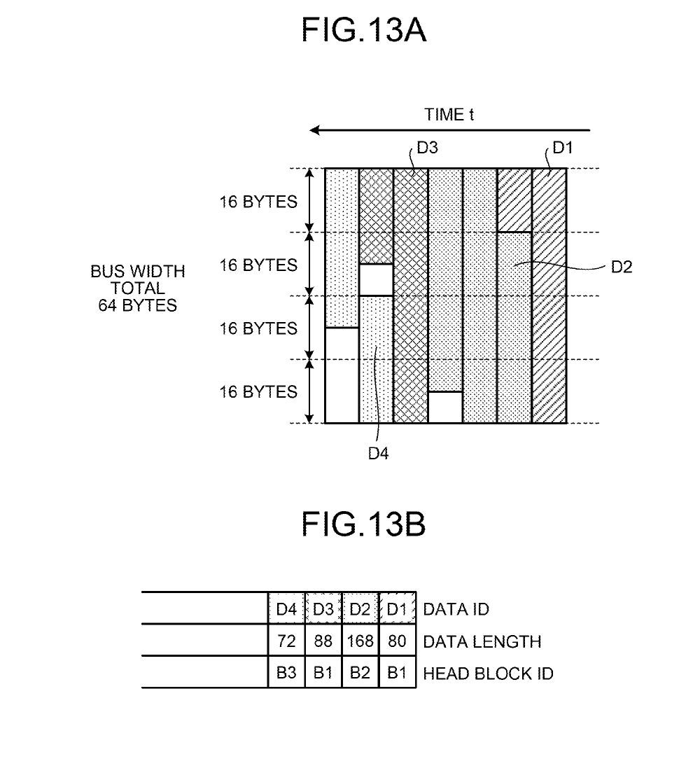

FIG. 13A is a diagram illustrating how the divided data blocks of the data D1 to D4 are written in the memory 20. As illustrated in FIG. 13A, the divided data blocks are written in the memory 20 in order from the head divided data blocks of each of the data D1 to D4, being stuffed so as to create as little gap (invalid region) as possible. With this arrangement, the invalid regions between the data D1 to D4 are at most 127 bits, which is calculated by subtracting 1 bit from 16 bytes (128 bits) (the width of the divided bus).

In FIG. 13A, a data transmission efficiency is calculated to be 0.944 by the following Equation (1).

408 bytes÷(16 bytes×27)=0.944 (1)

The above Equation (1) represents that a write bandwidth is improved; and in the memory control device 10, by further increasing the number of division to reduce the width of the divided block, the write bandwidth can be broader. Therefore, the number of division is not limited to four, and it is desirable that the number of division is as large as possible unless the circuit scale becomes too large.

At T15, the write-request distribution unit 11 previously stores the above pieces of information (for example, the write pointers, the data lengths, the head block IDs, and the types) as the information for restoring the divided data blocks in the data management unit 14 so that the divided data blocks can be correctly composed at the time of reading. FIG. 13B is a diagram illustrating how the data IDs, the data lengths, and the head block IDs are stored in the data management unit 14. As illustrated in FIG. 13B, for example, as the “data length” and the “head block ID” of the data D1, “80” bytes and “B1” are stored, respectively, in relation to the data ID “D1”. Similarly, for example, as the “data length” and the “head block ID” of the data D4, “72” bytes and “B3” are stored, respectively, in relation to the data ID “D4”.

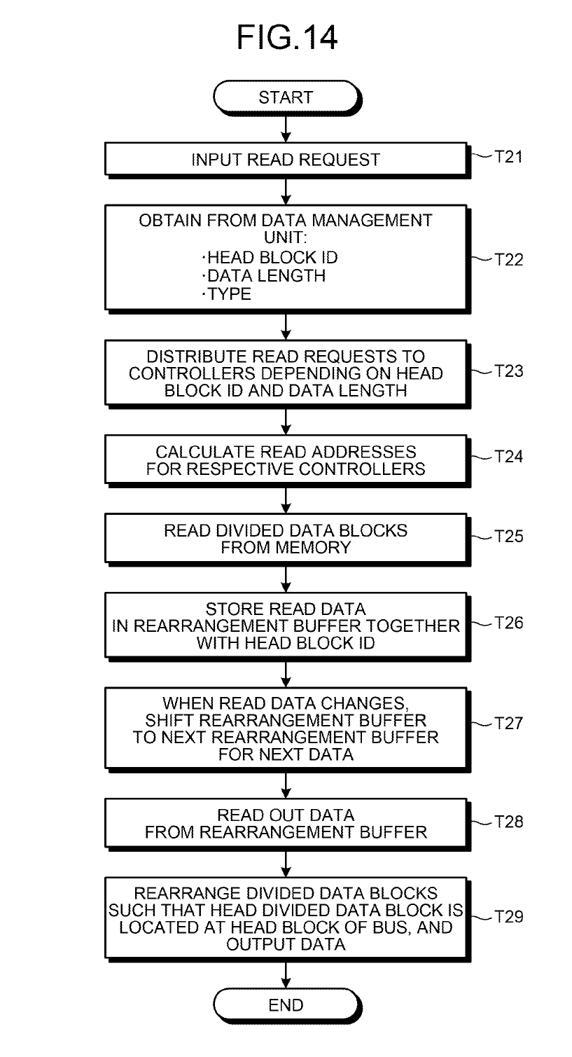

Next, the reading process will be described. FIG. 14 is a flowchart for describing the reading process to be performed by the memory control device 10.

Upon receiving the input of a read pointer as the read request from the queue management unit (T21), the read-request distribution unit 12 obtains the above pieces of information (for example, the head block IDs, the data lengths, and the types) previously stored at T15 from the data management unit 14, based on the read pointer (T22).

At T23, the read-request distribution unit 12 distributes the read requests input at T21 to the controllers 15a to 15d, based on the head block IDs and the data lengths obtained at T22. Next, the read-request distribution unit 12 calculates the read addresses for each of the controllers 15a to 15d, based on the head block IDs, the data lengths, and the type obtained at T22 (T24). At T25, the read-request distribution unit 12 refers to the read addresses calculated at T24 and reads the divided data blocks corresponding to the read addresses from the memory 20 through the controllers 15a to 15d.

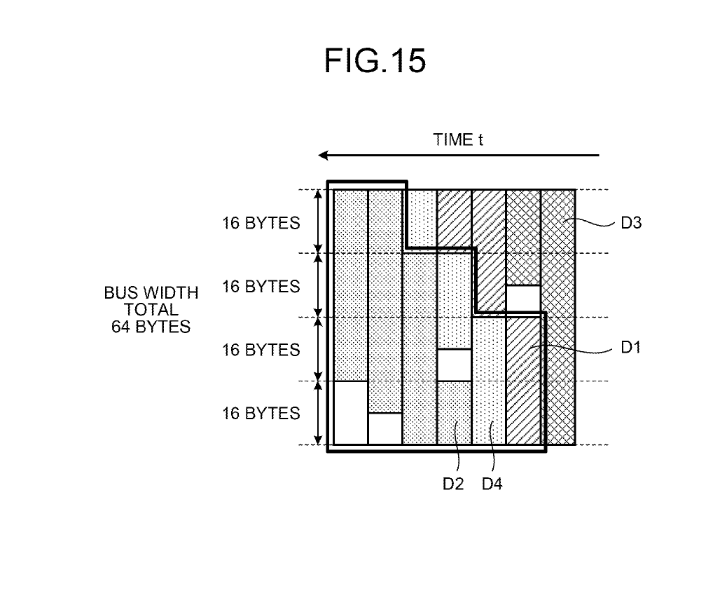

Here, taking as an example the case that the read requests are input in the order of the data D3, D1, D4, and D2, the reading process will be described in more detail. FIG. 15 is a diagram illustrating how the divided data blocks of the data D1 to D4 are read from the memory 20. As illustrated in FIG. 15, the divided data blocks are read from the memory 20 in order from the head divided data blocks of each of the data D3, D1, D4, and D2, being stuffed so as not to create gaps (invalid regions). Thus, the invalid regions between the data D1 to D4 are at most 127 bits, which is calculated by subtracting 1 bit from 16 bytes (128 bits) (the width of the divided bus). With this arrangement, the invalid regions between the data D3, D1, D4, and D2 are at most 127 bits, which is calculated by subtracting one bit from 16 bytes (128 bits), which is the width of the divided bus. In other words, an invalid region equal to or greater than the width of the divided blocks B1 to B4 is not created.

Thus, also in FIG. 15, the data transmission efficiency is calculated to be 0.944 by the following Equation (2), similarly to the case of FIG. 13A.

408 bytes÷(16 bytes×27)=0.944 (2)

The above Equation (2) represents that a read bandwidth is improved; and in the memory control device 10, by further increasing the number of division to reduce the width of the divided block, the read bandwidth can be broader. Therefore, the number of division is not limited to four, and it is desirable that the number of division is as large as possible unless the circuit scale becomes too large.

At T25, it is preferable that at the time of reading, the read-request distribution unit 12 assigns a frame number to each of the data D1 to D4 when obtaining the pieces of information corresponding to the data ID. The frame numbers are the data IDs which are reassigned in the order in which the data are actually read out. The read-request distribution unit 12 takes out the data D1 to D4 from the memory 20 according to the frame numbers in ascending order. With this arrangement, the memory control device 10 can output the data D1 to D4 to an external device in the correct order based on the input read request.

At T26, the read-data distribution unit 13 stores the read data read at T25 together with the head block ID in the rearrangement buffer 132, by the unit of the divided data block. When storing, the read-data distribution unit 13 makes a control to shift the rearrangement buffer 132 to the rearrangement buffer 132 for the next data as illustrated in FIG. 10 every time when the read data to be read changes (T27).

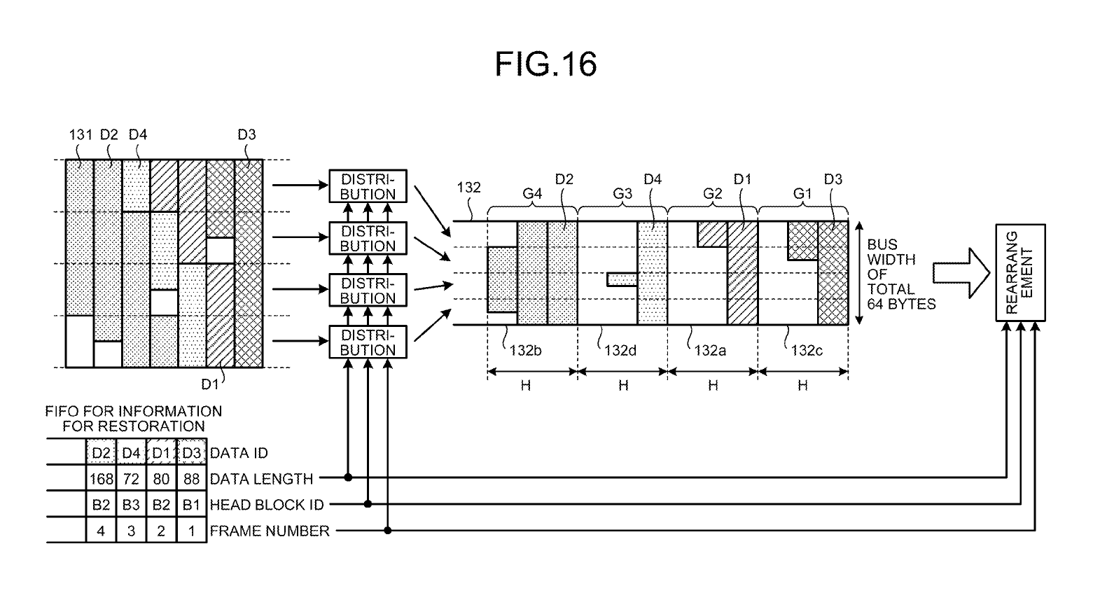

FIG. 16 is a diagram illustrating how the read data D1 to D4 are distributed from the read data buffer 131 to the rearrangement buffer 132. As illustrated in FIG. 16, the read-data distribution unit 13 calculates the number of the data (4 in this description of operation) to be restored, from the head block ID and the data length of the above pieces of information. Then, the read-data distribution unit 13 transfers the read data D1 to D4 to rearrangement buffers 132a to 132d corresponding to the read data D1 to D4, based on the above frame number G1 to G4. The transfer is independently done by the unit of the divided data block.

At T28, the read-data distribution unit 13 serially reads out the read data D3, D1, D4, and D2 from the rearrangement buffers 132c, 132a, 132d, and 132b. The read-out is independently done by the unit of the divided data block. At T29, the read-data distribution unit 13 refers to the head block ID stored in the data management unit 14 at T15, and then rearranges the divided data blocks such that the head divided data blocks of each of the read data D1 to D4 is located at the divided block B1 at the head of the bus, and the read-data distribution unit 13 then output the rearranged data. In this way, the divided data blocks are connected, and the original data D1 to D4 are restored.

Further, as illustrated in FIG. 16, the reading process is performed also to make the gap (invalid region) as small as possible, with the data being stuffed in each of the divided blocks B1 to B4. Consequently, although the divided data blocks of each of the read data D1 to D4 are once put in a non-contiguous state, the read-data distribution unit 13 can distinguish the data D1 to D4 from each other and rearrange the divided data blocks, by using the information for restoration (for example, the data IDs, the data lengths, the head block IDs, and the frame numbers).

Note that when transferring the data D1 to D4 between the buffers, the read-data distribution unit 13 arranges the data D1 to D4 in ascending order of the frame numbers according to the frame number assigned to each of the data D1 to D4, and which operation avoid the inconvenience that the order of outputting the data is different from the order of the read requests.

The read-data distribution unit 13 reads the divided data blocks from the rearrangement buffer 132 to output them, and the number of read for one frame is calculated by rounding up the valued obtained by dividing the data length by the bus width B. Thus, for example, in the case of the data D3 the number of read is calculated to be two (twice) according to the equation: (88 bytes)/(64 bytes)=1.375. Similarly, the number of read is calculated depending on each of the read data, for example, in the case of the data D2 the number of read is three times according to the equation: (168 bytes)/(64 bytes)=2.625.

The read-data distribution unit 13 outputs the data D3, D1, D4, and D2 in this order, incrementing the frame number; and before outputting the data, the read-data distribution unit 13 rearrange the divided data blocks based on the head block IDs such that the head divided blocks are located at the top. For example, in the case that the output data is the data D3, the read-data distribution unit 13 outputs the data D3 as they are without rearranging the divided data blocks (see FIGS. 15 and 16). On the other hand, for example, in the case that the output data is the data D4, the read-data distribution unit 13 outputs the data after rearranging the divided data blocks of the data D4 in the order of the divided blocks B3, B4, B1, and B2 (see FIGS. 15 and 16).

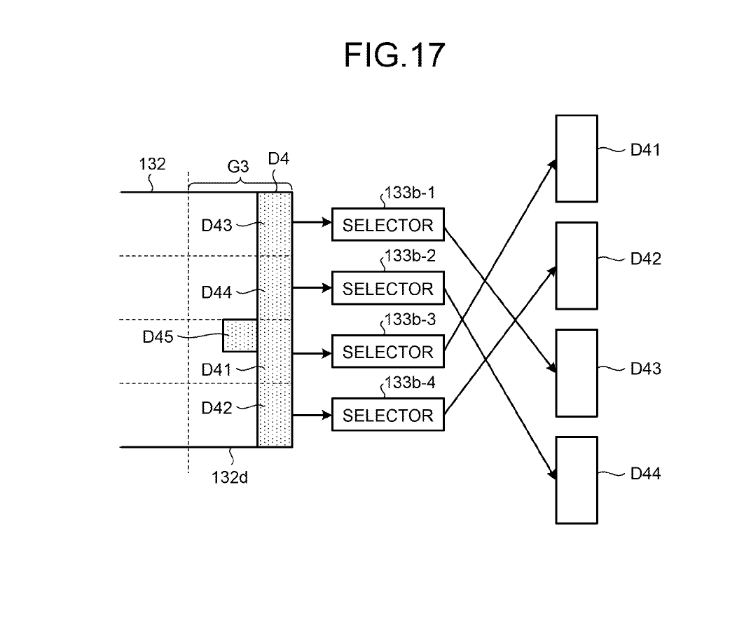

Taking the data D4 as an example, a description will be made in more detail below. FIG. 17 is a diagram illustrating how the divided data blocks D41 to D44 are rearranged by selectors 13a-1 to 13a-4 when the data D4 are output. As illustrated in FIG. 17, the read-data distribution unit 13 assigns the divided data block to the position number which is determined by the formula: the position of the divided data block to be output+(the position of the head divided block−1). Note that when the above position number exceeds 4, the position number returns to 1. For example, in a case that the position of the head divided block is the third divided block B3, the position number of the divided data block D43 is determined to be 3 according to the formula: 1+(3−1). Therefore, the divided data block D43 is arranged at the third position from the top of the bus by the selector 13a-1. In addition, the position number of the divided data block D44 is determined to be 4 according to the formula: 2+(3−1); thus, the divided data block D44 is arranged at the fourth position from the top by the selector 13a-2. Similarly, the position numbers of the divided data blocks D41 and D45 are determined to be 1 according to the formula: 3+(3−1); thus the divided data blocks D41 and D45 are arranged at the highest-order position by the selector 13a-3. Finally, the position number of the divided data block D42 is determined to be 2 according to the formula: 4+(3−1); thus the divided data block D42 is arranged at the second position from the top by the selector 13a-4. With this arrangement, the divided data blocks located at the head of each of the read data D1 to D4 are arranged at the head (the top) of the bus. Consequently, the memory control device 10 can read the read data D1 to D4 in the same state as in the time of writing.

As described above, the memory control device 10 has the write-request distribution unit 11 and the controllers 15a to 15d. The write-request distribution unit 11 divides the data D1 to be written in the memory 20, in the direction of the bus width B and then outputs the data, distributing the divided data blocks D11 to D16 obtained by the dividing to the buses B11 to B14. The controllers 15a to 15d writes the divided data blocks D11 to D16 output by the write-request distribution unit 11 in the memory 20 through the buses B11 to B14, without leaving any space the size of each of the buses between the data in each of the buses (see FIG. 1).

In the memory control device 10, it is preferable that the data management unit 14 obtains, when outputting the divided data blocks D11 to D16, the positions (for example, the head block IDs, the data lengths, the write pointers) at which the divided data blocks D11 to D16 are written in the memory 20. In addition, the read-request distribution unit 12 serially reads out the divided data blocks D11 to D16 written in a memory 29 by the controllers 15a to 15d, referring to the above positions obtained by the data management unit 14.

In the memory control device 10, it is preferable that the read-data distribution unit 13 outputs the divided data blocks D11 to D16 after rearranging the divided data blocks D11 to D16 such that the divided data blocks D11 to D16 read out by the read-request distribution unit 12 are in the correct order before divided by the write-request distribution unit 11.

In other words, the memory control device 10 individually writes and reads the data obtained by division, thereby minimizing invalid regions (parallel loss) as small as possible and improving the efficiency of arrangement of the data in the bus. With this arrangement, the transmission bandwidth is prevented from being reduced without complicating the data management method in the memory control device 10. As a result, the broadband transmission of data can be realized with the IP transmission device without speeding-up the circuit by increasing the operation frequency of the memory itself. Consequently, an efficient memory control is realized.

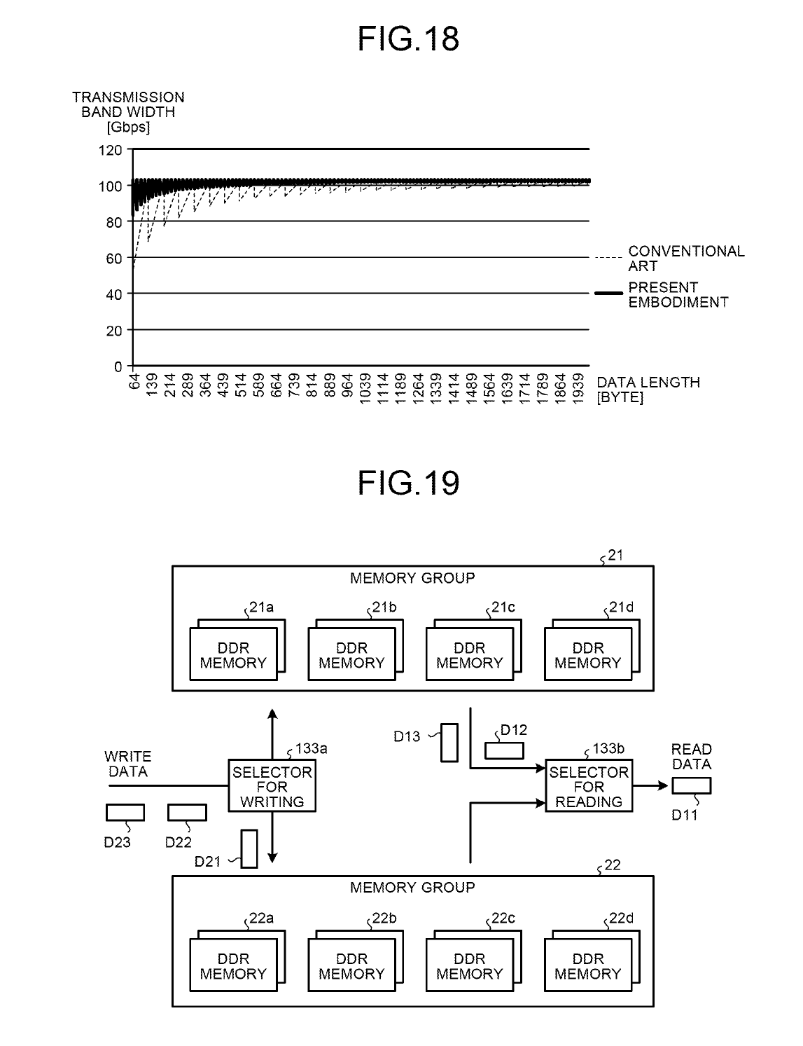

With reference to FIG. 18, the effect of the memory control by the memory control device 10 will be described in detail. As described above, in the memory control device 10, the width of the data processed by one controller is 16 bytes, which is narrower than the data width of 64 bytes of the memory 20; thus, the different data D1 to D3 can be processed with less space left between the data than in the related art. For example, it is assumed that the circuit has the bus width B of 64 bytes for data and is operated with a clock frequency of 200 MHz. In this case, when the 65-byte-length data are successively input into the memory control device 10, the transmission bandwidth can be calculated as follows.

First, since the memory control device of the related art processes one block of data by the unit of 64 bytes, the transfer efficiency is calculated to be (65 bytes)/(64 bytes×2)=0.51. Then, the transmission bandwidth is calculated to be 52.2 Gbps by Equation (3) below.

512 bits×200 MHz×0.51=52.2 Gbps (3)

In contrast, since the memory control device 10 according to the present embodiment divides one block of data in quarters to process them by the unit of 16 bytes, the transfer efficiency of the data is calculated to be (65 bytes)/(16 bytes×5)=0.81. Consequently, the transmission bandwidth is calculated to be 82.9 Gbps by Equation (4) below.

512 bits×200 MHz×0.81=82.9 Gbps Equation (4)

As illustrated above, in the present embodiment, the transmission bandwidth is improved by approximately 30 Gbps under the above assumptions, compared to the related art. A similar effect can be achieved with data lengths other than 65 bytes. FIG. 18 is a diagram for describing the effect of the memory control according to the present embodiment in contradistinction to the related art. In FIG. 18, the horizontal axis represents the data length (byte), and the vertical axis represents the transmission bandwidth (Gbps). As illustrated in FIG. 18, the smaller the data length is, in other words, the shorter the data length is, the greater the effect of the parallel loss due to the creation of invalid region is, whereby a greater effect is achieved. In the present embodiment, in particular, the improvement of the reduced bandwidth is remarkable with the data length of 200 bytes or shorter. Note that the value of the transmission bandwidth illustrated in FIG. 18 is a theoretical value, and any effect of other losses (for example, the loss due to switching between read and write, the loss due to refreshing) to be created in association with memory access is not counted.

### Modified Example 1

The memory control device 10 can be modified as described below. FIG. 19 is a diagram for describing a process for resolving conflict between read and write according to Modified Example 1. In Modified Example 1, the memory 20 is divided into two memory groups 21 and 22. The memory control device 10 separately controls each of the two memory groups 21 and 22 for both read and write to avoid waiting due to the conflict between the read data and the write data.

In other words, the memory control device 10 has therein the memory groups 21 and 22. When the write-in request and the read-out request to the divided data blocks D11 to D16 are concurrently issued, the write-request distribution unit 11 of the memory control device 10 instructs the controllers 15a to 15b to perform writing in response to such write-in request to a memory region different from the memory region from which the divided data blocks (for example, the divided data blocks D11 to D13) are read out in response to such read-out request.

In more particular, when the read request and the write request are not concurrently issued, the read-request distribution unit 12 of the memory control device 10 reads out the read data requested to be read, from the memory group in which such data are stored. In addition, the write-request distribution unit 11 of the memory control device 10 writes the write data requested to be written, in the memory group selected by a selector for writing 133a when the write request is input. In contrast, think of the case that the read request and the write request are concurrently issued. As for the read data, similarly to the case that the read request and the write request are not concurrently issued, the read-request distribution unit 12 reads out, through a selector for reading 133b, the read data from the memory group in which the data to be read are stored. On the other hand, as for the write data, the write-request distribution unit 11 selects the memory group opposite to the memory group of the memory groups 21 and 22 which is selected for reading, and writes in such memory group the data to be written. By this operation, the writing process is performed on the memory group on which no reading process is performed. As a result, the concurrent occurrence (conflict) of the reading process and the writing process within one memory group is prevented before it happens.

As a cause of the reduction in the transmission bandwidth, occurrence of the above described waiting can be cited in addition to the above described creation of the invalid region between the data; however, with the memory control device 10 according to Modified Example 1, both causes are resolved, whereby the transmission bandwidth can be further improved.

Note that although the bus width B is divided into quarters in the embodiment, the number of division is not limited thereto and can be any plural number. However, if the number of division is too large, a problem arises that the memory control device has to have increased number of controllers and the circuit scale gets large or more lines are requested for address control. Therefore, the number of division is preferably in the range (for example, division into about four to eight parts) which does not cause these problems.

Further, in the embodiment, since the bus width of total 512 bits is evenly divided into quarters in the memory control device 10, the lengths of the divided data blocks are made to be constant and identical to each divided bus width. However, in the case that each of the divided buses has different length, the lengths of the divided data blocks may also be different in conformity with the bus widths (for example, 128 bits and 256 bits).

Further, in the embodiment, the physical multiple buses (for example, four buses) communicate between the memory control device 10 and the memory 20; however, in the memory control device 10, one physical bus may be divided into plurals to make a plurality of logical buses.

The elements of the memory control device 10 are not necessarily physically structured as illustrated in the drawings. That is to say, specific aspects of disintegration and integration of the devices are not limited to one illustrated in the drawings, and all or part may be structured by functionally or physically disintegrating or integrating by an arbitrary unit depending on various loads or status of use. For example, either the read-request distribution unit 12 and the read-data distribution unit 13 or the write-request distribution unit 11 and the read-request distribution unit 12, in the memory control device 10, may be integrated as one element. Further, the memory for data management and the memory for request buffer may be commonalized. Alternatively, the data management unit 14 may be disintegrated into two parts, one for managing the write data and the other for managing the read data. Further, the memory 20 may be connected to the memory control device 10 through networks or cables. Similarly, the data management unit 14 may be assembled as an external device of the memory control device 10.

According to an aspect of a memory control device, a transmission bandwidth can be improved.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A memory control device comprising:
a distribution unit that divides data to be written in a memory and outputs a plurality of divided data blocks obtained by the division while distributing the divided data blocks to a plurality of buses; and
a plurality of controllers that write the plurality of divided data blocks output by the distribution unit in the memory through the plurality of buses, the divided data blocks being in contact with each other in each of the buses.

2. The memory control device of claim 1 further including:
an obtaining unit that, when the plurality of divided data blocks are output, obtains locations at each of which each of the divided data blocks is written in the memory; and
a read-out unit that refers to the locations obtained by the obtaining unit and consecutively read out the plurality of divided data blocks written in the memory by the plurality of controllers.

3. The memory control device of claim 2 further including a rearrangement unit that rearranges the plurality of divided data blocks in an order in which the plurality of divided data blocks read out by the read-out unit were arranged before being divided by the distribution unit, and outputs the divided data blocks having been rearranged.

4. The memory control device of claim 1, wherein
the memory includes a plurality of memory regions and
when a write-in request and a read-out request of the plurality of divided data blocks are concurrently issued, the distribution unit instructs to perform writing, in response to the write-in request, to the memory region different from the memory region from which the divided data blocks are read out in response to the read-out request.

5. A memory control method comprising:
causing a memory control device to divide data to be written in a memory, output a plurality of divided data blocks obtained by the division while distributing the divided data blocks to a plurality of buses; and
causing the memory control device to write the plurality of divided data blocks having been output in the memory through the plurality of buses, the divided data blocks being in contact with each other in each of the buses.
